(19) United States
(12) Patent Application Publication
(10) Pub. No.: US 2024/0026928 A1
(43) Pub. Date: Jan. 25, 2024

(54) SEALING ANTI-FRICTION BEARING

(71) Applicant: Schaeffler Technologies AG & Co. KG, Herzogenaurach (DE)

(72) Inventors: Thomas Fickert-Guenther, Hirschaid (DE); Peter Reif, Erlangen (DE); Armin Bender, Herzogenaurach (DE); Christian Schmidt, Herzogenaurach (DE)

(73) Assignee: Schaeffler Technologies AG & Co. KG, Herzogenaurach (DE)

(21) Appl. No.: 18/245,503

(22) PCT Filed: Jul. 5, 2021
(86) PCT No.: PCT/DE2021/100581

§ 371 Date: Mar. 15, 2023

(30) Foreign Application Priority Data
Oct. 5, 2020 (DE) 102020125963.8

(51) Int. Cl. F16C 33/78

(52) U.S. Cl. CPC F16C 33/7823; F16C 33/7853; F16C 2240/60; F16C 19/04

(57) ABSTRACT

A sealed anti-friction bearing, consisting of an inner bearing ring with a raceway arranged on its outer shell surface, of an outer bearing ring with a raceway arranged on its inner shell surface, and of a multiplicity of rolling bodies which roll between the bearing rings on the raceways, wherein two circumferential annular grooves are machined into the inner shell surface of the outer bearing ring axially on both sides next to the raceway in the outer bearing ring, in which annular grooves two seals are fastened which consist in each case of a circularly annular reinforcement and of an elastomer coating and which, on their inner circumference, comprise in each case one first radial sealing lip which bears against axial surfaces of two undercuts arranged on both sides next to the raceway in the inner bearing ring, in each case one second axial sealing lip which bears against radial surfaces of the undercuts in the inner bearing ring, and in each case one third sealing lip which forms a sealing gap together with the undercuts in the inner bearing ring (2).

### CROSS-REFERENCE TO RELATED APPLICATIONS

This application is the U.S. National Phase of PCT Appln. No. PCT/DE2021/100581, filed Jul. 5, 2021, which claims the benefit of German Patent Appln. No. 102020125963.8, filed Oct. 5, 2020, the entire disclosures of which are incorporated by reference herein.

### TECHNICAL FIELD

The disclosure relates to a sealed anti-friction bearing, and it can be used particularly advantageously on radial deep groove ball bearings which are used in a bottom bracket for a bicycle with an electric motor assistance drive.

### BACKGROUND

It is generally known that bottom brackets are those bearings on a bicycle in which the bottom bracket shaft, which is connected at its ends to the pedal cranks, is mounted. Such bottom brackets consist in most cases of at least two anti-friction bearings which support the bottom bracket shaft on both sides of the bottom bracket shell. In modern bicycles, the anti-friction bearings of the bottom bracket are formed by exchangeable bearing units, which most often consist of radial deep groove ball bearings sealed on both sides due to their low frictional resistance.

Such a sealed deep groove ball bearing is already known, for example, from the publication DE 10 2005 029 936 A1. In a known manner, this deep groove ball bearing consists of an inner bearing ring with a raceway arranged on its outer shell surface, an outer bearing ring with a raceway arranged on its inner shell surface, as well as a plurality of rolling bodies rolling between the bearing rings on the raceways, which are kept at uniform distances from one another by a cage. In addition, two circumferential annular grooves are machined axially on both sides next to the raceway in the outer bearing ring into the inner shell surface of the outer bearing ring, in which two seals, each consisting of a circular reinforcement and an elastomer coating, are fastened with their outer diameter. On the part facing the inner bearing ring, the seals have an elastic carrier part, from which two sealing lips each extend, which interact with an undercut arranged in the inner bearing ring, wherein the undercut is designed asymmetrically in such a way that a first shoulder adjoining the raceway and an outer second shoulder are formed, which differ in their diameter. In this regard, an axially inwardly directed first sealing lip rubs against an inner wall of the undercut, while a second axially outwardly directed sealing lip forms a first gap seal with the outer shoulder. A third inwardly directed sealing lip is also arranged at a radial distance from the first two sealing lips and forms a second gap seal with the first shoulder.

In practice, however, it has been shown that, particularly when cleaning a bicycle with a high-pressure cleaner, the performance of the seals used for the deep groove ball bearing in the bottom bracket is not sufficient to reliably prevent dirty water from ingressing into the anti-friction bearings. The sharp water jet from the high-pressure cleaner would cause water to ingress through the first gap seal, which during bearing operation would progress into the interior of the bearing as a result of the first sealing lip lifting from the inner wall of the undercut on the inner bearing ring and would cause bearing damage that would reduce the service life due to oxidation with bearing components.

In contrast, the seals of the deep groove ball bearing disclosed in U.S. Pat. No. 5,037,213 A offer an improved sealing performance. This deep groove ball bearing also consists of an inner bearing ring with an outer raceway, an outer bearing ring with an inner raceway as well as a plurality of rolling bodies rolling between the bearing rings, which are kept at uniform distances from one another by a cage. Likewise, two circumferential annular grooves are machined axially on both sides next to the raceway in the outer bearing ring into the inner shell surface of the outer bearing ring, in which two seals, each consisting of a circular reinforcement and an elastomer coating, are fastened with their outer diameter. On their inner circumference, the seals each have a first radial sealing lip resting against axial surfaces of two undercuts arranged next to the raceway in the inner bearing ring, a second axial sealing lip resting against radial surfaces of the undercuts in the inner bearing ring, and a third sealing lip forming a sealing gap together with the undercuts in the inner bearing ring.

The disadvantage of the seals used here, however, is that the three sealing lips are positioned on a single main sealing lip and thus influence each other. In the static and dynamic state of the seals, this leads to discontinuities in the contacts of the first and second sealing lips and in the gap geometry of the third sealing lip, which can lead to the ingress of dirty water into the interior of the deep groove ball bearing with the undesirable consequences mentioned.

### SUMMARY

Based on the disadvantages of the solutions of the known prior art, the present disclosure is therefore based on the object of designing a sealed anti-friction bearing, the seals of which have an improved sealing performance compared to a standard bearing with the same installation space and reliably prevent dirty water from ingressing into the interior of the bearing.

According to the disclosure, this object is achieved in a sealed anti-friction bearing in such a way that the radial sealing lips and the axial sealing lips of the two seals are oriented substantially radially in the profile cross section and are formed integrally, so as to be spaced apart axially from one another, on the ends of axial attachments of the elastomer coatings, which axial attachments in each case enclose the internal diameter region of the reinforcements of said seals, wherein the radial thickness of each axial attachment is smaller than the axial width of each radial sealing lip and of each axial sealing lip.

Preferred embodiments and advantageous further developments of the sealed anti-friction bearing according to the disclosureare described.

In the sealed anti-friction bearing designed according to the disclosure, it is provided that the radial sealing lips of the seals have a rectangular profile cross section and, in the installed state, form circumferential sealing edges with an inner profile edge of their free ends, forming central curvatures directed inwards towards the bearing, which sealing edges rest on the axial surfaces of the undercuts in the inner bearing ring. The central curvatures of the radial sealing lips arise from the fact that their internal diameters in the stretched state are slightly smaller than the diameters of the axial surfaces of the undercuts in the inner bearing ring, in order to generate a constant contact pressure on the sealing edges of the radial sealing lips.

Another feature of the sealed anti-friction bearing designed according to the disclosure is that the axial sealing lips of the seals have a rectangular profile cross section with free ends angled inwards towards the bearing and, in the installed state, form circumferential sealing surfaces with the faces of their free ends, which sealing surfaces bear against the radial surfaces of the undercuts on the inner bearing ring. In order to also generate a constant contact pressure of the end faces of the free ends of the axial sealing lips on the radial surfaces of the undercuts in the inner bearing ring, the axial distance of the end faces of the free ends to the side surfaces of the inner bearing ring when the seals are not installed is greater than the axial distance of the radial surfaces of the undercuts to the side surfaces of the inner bearing ring.

The sealed anti-friction bearing designed according to the disclosure is also characterized in that the sealing edges on the radial sealing lips and the sealing surfaces on the axial sealing lips of the seals are at least approximately arranged in the same radial plane or in the same diameter region of the seals. This allows optimal use of the radial installation space available for the seals without critically weakening the remaining wall thickness of the individual sealing lips of the seals.

An expedient further development of the sealed anti-friction bearing designed according to the disclosure is that the third sealing lips of the seals are arranged in the profile cross section above the axial sealing lips and are axially aligned inwards towards the bearing and, in the installed state, together with the axial sealing lips form the sealing gaps to the radial surfaces of the undercuts in the inner bearing ring. The axial extent of the third sealing lips corresponds approximately 9*8/++ with narrow openings to the bearing interior are created.

Finally, it is also proposed as an advantageous embodiment of the sealed anti-friction bearing designed according to the disclosure that the reinforcements of the seals in the profile cross section each have outer end regions angled at right angles inwards towards the bearing from a radial central part and inner end regions angled obliquely inwards towards the bearing from the central part. The direct internal diameter region of the reinforcements is ultimately aligned radially again in order to be able to form the attachments of the axial sealing lips and radial sealing lips of the seals with a uniform elastomer thickness.

The sealed anti-friction bearing designed according to the disclosure thus has the advantage over the sealed anti-friction bearings known from the prior art that, due to a substantially radial alignment and axial spacing of the radial sealing lips and the axial sealing lips of both seals and due to their being formed on axial attachments of the elastomer coatings, each of which encloses the internal diameter region of their reinforcements, the radial thickness of which is smaller than the axial width of each radial sealing lip and each axial sealing lip, the sealing lips can no longer influence each other, which in the static and dynamic state of the seals leads to discontinuities in the contacts of the first and second sealing lips as well as in the gap geometry of the third sealing lip, such that the ingress of dirty water into the interior of the bearing is ruled out.

### BRIEF DESCRIPTION OF THE DRAWINGS

A preferred embodiment of the sealed anti-friction bearing designed according to the disclosure is explained in more detail below with reference to the accompanying drawings. In the figures:

FIG. 1 shows an enlarged partial view of a cross section through a sealed anti-friction bearing designed according to the disclosure;

FIG. 2 shows a cross sectional view of a seal of the anti-friction bearing designed according to the disclosure according to detail X in FIG. 1;

FIG. 3 shows an enlarged representation of the sealing lips of the seal according to detail Z in FIG. 2.

### DETAILED DESCRIPTION

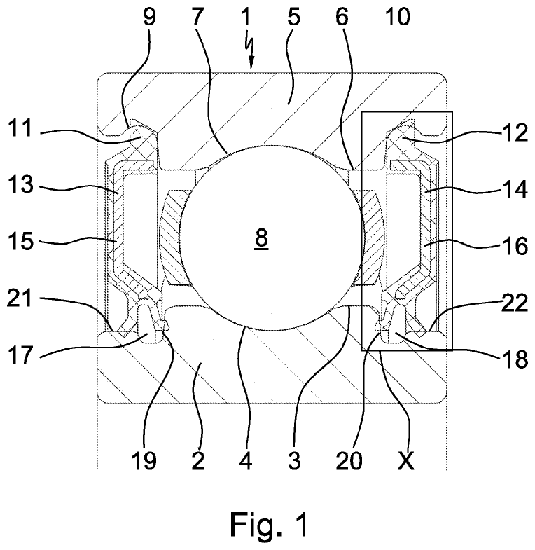

FIG. 1 clearly shows an anti-friction bearing 1 designed as a radial deep groove ball bearing, which consists of an inner bearing ring 2 with a raceway 4 arranged on its outer shell surface 3, an outer bearing ring 5 with a raceway 7 arranged on its inner shell surface 6, as well as a plurality of rolling bodies 8 rolling between the bearing rings 2, 5 on the raceways 4, 7, which are kept at uniform distances from one another by a cage (not described in more detail).

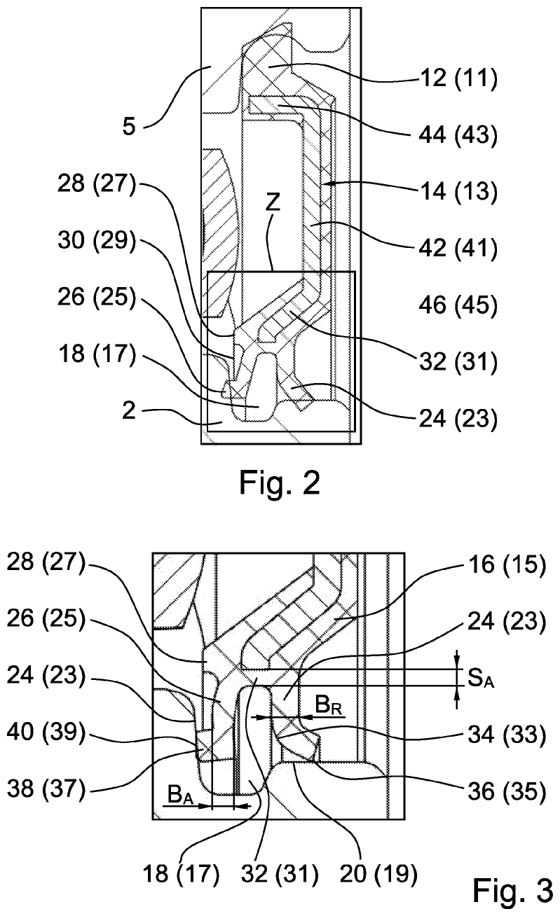

It can also be seen in FIG. 1 that two circumferential annular grooves 9, 10 are machined into the inner shell surface 6 of the outer bearing ring axially on both sides next to the raceway 7 in the outer bearing ring 5, in which annular grooves two seals 11, 12 are fastened which consist in each case of a circularly annular reinforcement 13, 14 and of an elastomer coating 15, 16 and which, as can be seen in FIG. 2, on their inner circumference, comprise in each case one first radial sealing lip 23, 24 which bears against axial surfaces 19, 20 of two undercuts 17, 18 arranged on both sides next to the raceway 4 in the inner bearing ring 2, in each case one second axial sealing lip 25, 26 which bears against radial surfaces 21, 22 of the undercuts 17, 18 in the inner bearing ring 2, and in each case one third sealing lip 27, 28 which forms a sealing gap 29, 30 together with the undercuts 17, 18 in the inner bearing ring 2.

It is also clearly shown in FIGS. 2 and 3 that the radial sealing lips 23, 24 and the axial sealing lips 25, 26 of the two seals 11, 12 are oriented substantially radially in the profile cross section and are formed integrally, so as to be spaced apart axially from one another, on the ends of axial attachments 31, 32 of the elastomer coatings 15, 16, which axial attachments in each case enclose the internal diameter region of the reinforcements 13, 14 of said seals. The radial thickness SA of each axial attachment 31, 32 is smaller than the axial width BR, BA of each radial sealing lip 23, 24 and each axial sealing lip 25, 26, in order to thus avoid a mutual influence of the sealing lips 23, 24 and 25, 26, which leads to discontinuities in the contacts of the radial and axial sealing lips 23, 24, 26 as well as in the gap geometry of the third sealing lip 27, 28 in the static and dynamic state of the seals 11, 12.

The representation according to FIG. 3 also shows that the radial sealing lips 23, 24 of the seals 11, 12 have a rectangular profile cross section and, in the installed state, form circumferential sealing edges 35, 36 with an inner profile edge of their free ends, forming curvatures 33, 34 directed inwards towards the bearing, which sealing edges rest on the axial surfaces 19, 20 of the undercuts 17, 18 in the inner bearing ring 2. The axial sealing lips 25, 26 of the seals 11, 12 also have, as is clearly visible, a rectangular profile cross section, but with free ends 37, 38 angled inwards towards the bearing and, in the installed state, form circumferential sealing surfaces 39, 40 with the faces of their free ends 37, 38, which sealing surfaces bear against the radial surfaces 23, 24 of the undercuts 17, 18 in the inner bearing ring 2. It can be seen in FIG. 3 that the sealing edges 35, 36 on the radial sealing lips 23, 24 and the sealing surfaces 39, 40 on the axial sealing lips 25, 26 are at least approximately arranged on the same radial plane or in the same diameter region of the seals 11, 12, such that the radial installation space available for the seals 11, 12 is optimally used without critically weakening the remaining wall thickness of the individual sealing lips 23, 24, 25, 26.

It can also be seen in FIG. 3 that the third sealing lips 27, 28 of the seals 11, 12 are arranged in the profile cross section above the axial sealing lips 25, 26 and are axially aligned inwards towards the bearing and, in the installed state, together with the axial sealing lips 25, 26 form the sealing gaps 29, 30 to the radial surfaces 21, 22 of the undercuts 17, 18 in the inner bearing ring 2. The axial extent of the third sealing lips 27, 28 corresponds approximately to the axial extent of the axial sealing lips 25, 26 of the seals 11, 12, such that annular sealing gaps 29, 30 with narrow openings to the bearing interior are created

Finally, in FIGS. 1 and 2 it can also be seen that the reinforcements 13, 14 of the seals 11, 12 in the profile cross section each have outer end regions 43, 44 angled at right angles inwards towards the bearing from a radial central part 41, 42 and inner end regions 45, 46 angled obliquely inwards towards the bearing from the central part 41, 42. The direct internal diameter region of the reinforcements 13, 14 is ultimately aligned radially again in order to be able to form the attachments 31, 32 of the axial sealing lips 25, 26 and radial sealing lips 23, 24 of the seals 11, 12 with a uniform elastomer thickness.

LIST OF REFERENCE SYMBOLS

| | |
|---|---|
| 1 | Anti-friction bearing |
| 2 | Inner bearing ring of 1 |
| 3 | Outer shell surface of 2 |
| 4 | Raceway in 3 |
| 5 | Outer bearing ring of 1 |
| 6 | Inner shell surface of 5 |
| 7 | Raceway in 6 |
| 8 | Rolling bodies of 1 |
| 9 | Annular groove in 6 |
| 10 | Annular groove in 6 |
| 11 | Seal |
| 12 | Seal |
| 13 | Reinforcement of 11 |
| 14 | Reinforcement of 12 |
| 15 | Elastomer coating of 13 |
| 16 | Elastomer coating of 14 |
| 17 | Undercut in 2 |
| 18 | Undercut in 2 |
| 19 | Axial surface of 17 |
| 20 | Axial surface of 18 |
| 21 | Radial surface of 17 |
| 22 | Radial surface of 18 |
| 23 | Radial sealing lip on 11 |
| 24 | Radial sealing lip on 12 |
| 25 | Axial sealing lip on 1H1 |
| 26 | Axial sealing lip on 12 |
| 27 | Third sealing lip on 11 |
| 28 | Third sealing lip on 12 |
| 29 | Sealing gap |
| 30 | Sealing gap |
| 31 | Axial attachment on 11 |
| 32 | Axial attachment on 12 |
| 33 | Curvature on 23 |
| 34 | Curvature on 24 |
| 35 | Sealing edge on 23 |
| 36 | Sealing edge on 24 |
| 37 | End of 25 |
| 38 | End of 26 |
| 39 | Sealing surface on 37 |
| 40 | Sealing surface on 38 |
| 41 | Central part of 13 |
| 42 | Central part of 14 |
| 43 | Outer end region of 13 |
| 44 | Outer end region of 14 |
| 45 | Inner end region of 13 |
| 46 | Inner end region of 14 |
| S_{A} | Radial thickness of 31/32 |
| B_{R} | Axial width of 23/24 |
| B_{A} | Axial width of 25/26 |

1. A sealed anti-friction bearing comprising:
an inner bearing ring with a raceway arranged on an outer shell surface;
an outer bearing ring with a raceway arranged on its an inner shell surface; and
multiple rolling bodies between the bearing rings on the raceways
wherein two circumferential annular grooves in the inner shell surface of the outer bearing ring are disposed (axially on both sides next to the raceway of in the outer bearing ring, in which annular grooves two seals are received which include in each case a circularly annular reinforcement and an elastomer coating and which, on an inner circumference, include in each case
one first radial sealing lip which bears against axial surfaces of two undercuts arranged on both sides next to the raceway of the inner bearing ring,
one second axial sealing lip which bears against radial surfaces of the undercuts in the inner bearing ring, and
one third sealing lip which forms a sealing gap together with the undercuts in the inner bearing ring, wherein the radial sealing lips and the axial sealing lips of the two seals are oriented substantially radially in a profile cross section and are formed integrally, so as to be spaced apart axially from one another, on the ends of axial attachments of the elastomer coatings, which axial attachments in each case enclose an internal diameter region of the reinforcements of said seals, wherein a radial thickness of each axial attachment is smaller than an axial width of each radial sealing lip and of each axial sealing lip.

2. The sealed anti-friction bearing according to claim 1, wherein the radial sealing lips of the seals have a rectangular profile cross section and, in the installed state, form circumferential sealing edges with an inner profile edge of their free ends, forming curvatures directed inwards towards the bearing, which the sealing edges rest on the axial surfaces of the undercuts in the inner bearing ring.

3. The sealed anti-friction bearing according to claim 1, wherein the axial sealing lips of the seals have a rectangular profile cross section with free ends angled inwards towards the bearing and, in the installed state, form circumferential sealing surfaces with the faces of their free ends, which sealing surfaces bear against the radial surfaces of the undercuts in the inner bearing ring.

4. The sealed anti-friction bearing according to claim 2, wherein the sealing edges on the radial sealing lips and the sealing surfaces on the axial sealing lips are at least approximately arranged in the same radial plane or in the same diameter region of the seals.

5. The sealed anti-friction bearing according to claim 1, wherein the third sealing lips of the seals are arranged in the profile cross section above the axial sealing lips and are axially aligned inwards towards the bearing and, in the installed state, together with the axial sealing lips form the sealing gaps to the radial surfaces of the undercuts in the inner bearing ring.

6. The sealed anti-friction bearing according to claim 5, wherein the reinforcements of the seals in the profile cross section each have outer end regions angled at right angles inwards towards the bearing from a radial central part and inner end regions angled obliquely inwards towards the bearing from the central part, wherein a direct internal diameter region is again radially oriented.

7. A sealed anti-friction bearing comprising:
an inner bearing ring having an outer surface with a first raceway;
an outer bearing ring having an inner surface with a second raceway; and
rolling bodies between the bearing rings on the first and second raceways;
the inner surface of the outer bearing has a circumferential annular groove on each axial side of the second raceway;
the outer surface of the inner bearing has a circumferential undercut on each axial side of first raceway;
a seal is positioned in each said annular groove; wherein at least one of the seals includes:
a circularly annular reinforcement and an elastomer coating;
a radial sealing lip on an inner circumference thereof which bears against an axial surface of a respective undercut;
an axial sealing lip which bears against a radial surface of a respective undercut, and;
a third sealing lip which forms a sealing gap together with a respective undercut;
wherein the radial sealing lip and the axial sealing lip are oriented substantially in a radial direction and are formed integrally, so as to be spaced apart axially from one another, on ends of an axial attachment of the elastomer coatings the axial attachment enclosing an internal diameter region of the reinforcement of the seal, and a radial thickness of the axial attachment is smaller than an axial width of the radial sealing lip and of the axial sealing lip.

8. The sealed anti-friction bearing according to claim 7, wherein the radial sealing lip of each seal has a rectangular profile cross section and, in the installed state, forms a circumferential sealing edge with an inner profile edge forming curvatures directed inwards towards the bearing, the sealing edge resting on the axial surface of a respective undercut in the inner bearing ring.

9. The sealed anti-friction bearing according to claim 7, wherein the axial sealing lip of each seal has a rectangular profile cross section with a free end angled inwards towards the bearing and, in the installed state, forms a circumferential sealing surface with a face of the free end, which sealing surface bears against the radial surface of a respective undercut in the inner bearing ring.

10. The sealed anti-friction bearing according to claim 8, wherein the sealing edge on the radial sealing lip and the sealing surface on the axial sealing lip of each seal are at least approximately arranged in the same radial plane or in the same diameter region of the seal.

11. The sealed anti-friction bearing according to claim 7, wherein the third sealing lip of each seal is arranged in the profile cross section above the axial sealing lip and is axially aligned inwards towards the bearing and, in the installed state, together with the axial sealing lip form the sealing gap to the radial surface of the undercut in the inner bearing ring.

12. The sealed anti-friction bearing according to claim 11, wherein the reinforcement of each seal in the profile cross section has an outer end region angled at a right angle inwards towards the bearing from a radial central part and an inner end region angled obliquely inwards towards the bearing from the central part.
